(19) United States
(12) Patent Application Publication
(10) Pub. No.: US 2010/0066641 A1
(43) Pub. Date: Mar. 18, 2010

(54) Controlled Lighting System and Use of Such a System

(76) Inventors: Christoph Kronhagel, Bonn (DE); Ralf Mueller, Much (DE)

Correspondence Address: COLLARD & ROE, P.C., 1077 NORTHERN BOULEVARD, ROSLYN, NY, 11576, US

(21) Appl. No.: 12/227,370

(22) PCT Filed: Apr. 17, 2007
(86) PCT No.: PCT/DE2007/000675

§ 371 Date: Mar. 11, 2009

Related U.S. Application Data
(60) Provisional application No. 60/809,375, filed on May 30, 2006.

(30) Foreign Application Priority Data
May 16, 2006 (DE) 10 2006 023 107.4

(51) Int. Cl. G09G 5/00; G06F 17/30

(52) U.S. Cl. 345/1.1; 707/705; 707/E17.001

(57) ABSTRACT

Programming illuminated displays in open spaces poses special challenges to the operator. The invention proposes a controlled lighting system and the use of such a system. An exemplary program is generated, which is highly variable, and hence can be approved for open spaces.

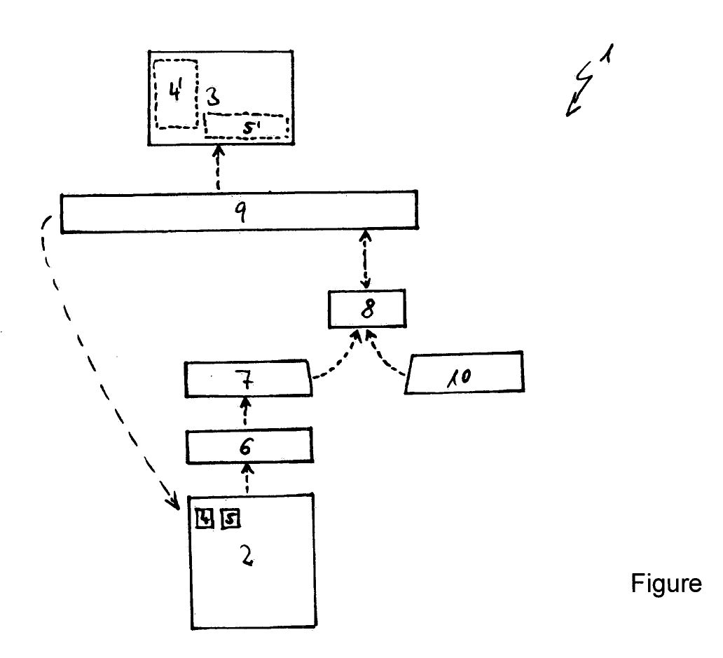

The invention relates to a controlled lighting system and the use of such a system. In particular, the invention relates to a controlled lighting system with a display device having a flat display, and with an EDP system that controls the display device.

Within the framework of this patent application, a display device with a flat display is to be in particular an illuminated media façade. Media facades had their origin in illuminated advertisement displays. Structures have since become known that depict texts, images and videos on a flat display resolved into pixels, and are made visible to the viewer through light emission.

However, programming a media façade in an open space poses special challenges to the operator:

First of all, moving images are perceived differently in an open space than in enclosed spaces. A viewer instinctively feels himself exposed to numerous dangers in open spaces, and therefore exercises a smaller share of his perceptive capabilities to electronically displayed images than in private spaces. As a result, media facades cannot be programmed in the usual manner, e.g., by playing back a film in a theater or on a television. Rather, the desired communicative effect must be achieved in a much shorter time.

In addition, media facades can easily pose irritations in road traffic. From the standpoint of traffic psychology, it is therefore necessary that a media façade not be programmed for “story telling”. In other words, no stories can be told that might cause the driver to involuntarily lose concentration on traffic.

In addition, a media façade can be operated 24 hours a day. Having the program play the same thing over and over again might place a mental burden on inhabitants living in proximity to such a media façade. However, it is impossible as a practical matter for the media façade operator to compile enough content as to avoid this impression.

There is also the problem that media facades are often suspended from prominent buildings, so that the contour of the building surface determines the shape of the media façade, and hence also the shape of the flat display. However, graphic content, e.g., an image or video file, is usually in a format commonly to television or computer screens, i.e., in a 4:3 or 16:9 format, wherein the two numbers denote the aspect ratio of the rectangular display surface.

The object of the invention is to provide a lighting system with a flat display that avoids or at least minimizes the disadvantages cited.

This invention achieves the object of a controlled lighting system with a display device having a flat display, and with an EDP system that controls the display device, which can access the content pool and is set up to feed the display with contents from the content pool, wherein the EDP system exhibits content linking means set up to establish logical links between content each provided with content designations, wherein the EDP system also exhibits layout means to which the links are relayed, and wherein the layout means are set up to chronologically and/or geometrically assign the linked contents in such a way that as to display them on the display device via illumination.

For clarification of terms, let it be noted in this respect that the content pool can as a rule be a database that can contain text files, image files and/or video files, but also music files. Each file has a designation that denotes at least the data type. The operator of the display device has a relatively free hand in setting the content designation. For example, it is conceivable in particular that the content designation be linked with specific thematic areas, such as specific graphic representations of a city or company, a sports facility, a current event news item, and countless other potential focal points, which can each represent a coherent group. This type of content designation can already be very useful to the operator even if it contains just a number, for example the number of a client who is paying fees for display time on the display device, or the number of a specific range of content files which the operator can designate via manual selection in such a way that the content linking means can establish logical links between the latter.

Therefore, the content linking means are able to logically link together two graphic representations. This logical linking is now relayed to the layout means within the EDP system, preferably within two components of the EDP system. The layout means derive the logical link which the content linking means impart to them, telling them that the two graphic representations are contextually related. The layout means then arrange the graphic representations in a playback program.

The playback program offsets the two graphic representations relative to each other chronologically and/or in the display surface, so that both graphic representations can be discerned by the viewer on the flat display without distortion, either simultaneously or chronologically staggered. The decision how to achieve the offset, meaning chronologically or in the display surface, as well as the ensuing decision as to which offset to use in displaying the two representations can be made via the layout means, being guided in particular by the best possible utilization of the display surface of the display. However, a random algorithm can also be programmed.

The display device is preferably installed in the open space. As already explained, precisely displays in open spaces must overcome special difficulties. Layout is also very important there, since open displays can be expensive to install and maintain. Therefore, it is recommended for displays in open spaces that the available display surface be utilized as efficiently as possible.

The invention can be used especially suitably when the controlled lighting system exhibits several display devices, each with a flat display. In particular, at least three display devices can be incorporated into the system, each with varying aspect ratios for rectangular displays.

As already explained, graphic representation often pose special challenges having to do with depicting an image or film on a display having a different aspect ratio than the data in the graphically displayable file. In this case, it is preferable for the depiction to still be without any distortion. To this end, the layout means must introduce an undistorted depiction by relaying the graphic contents to the display device with a corresponding indication of the intended size and positioning of the contents on the display.

If several displays each with varying aspect rations must be illuminated, the layout means make it possible to relay different respective layouts for the various displays with the contents to the display devices. While the same contents as a whole then appear on the different displays, they differ from each other spatially and/or chronologically. Put differently, the layout means generate a differing playback program on the displays varying in format, but depicts the same contents as a whole, specifically all the contents that were logically linked by the content linking means.

A display device can be especially flexibly used for depiction purposes, and hence allow the layout means to also work very dynamically if they exhibit a display that can be activated via pixels.

Simulations have shown that in particular rectangular displays with an aspect ratio of narrower than 16:9 are highly suitable for dynamic programming with the present invention. Most graphic displays are preformatted for the 4:3 or 16:9 format. In depictions on a display narrower than the 16:9 format, meaning where the long edge is more than 16 ninths the length of the short edge, such an image or video file can only be represented with a remaining unused portion of the display surface, if depiction is to occur without distortion. This unused portion of the display can be utilized by the layout means to depict other contents. While these other contents can be varied in size, they can also retain their aspect ratio in the process, and hence also be depicted without distortion. In sum, then, narrow display surfaces can be used to calculate the positioning of two or more graphic depictions already from a very simple algorithm, wherein the simplest case involves showing a first graphic depiction in maximum possible size, and using the residual surface for additional graphic depictions. The residual surface can be hierarchically made available for several additional combined graphic depictions.

In one preferred embodiment of the lighting system, several display device's are spatially separated from each other and controlled by an EDP system. In this way, the different display devices, for example in a city, can be distributed over their open display devices. As an alternative and additionally, the display devices can also be distributed over several cities or countries. Despite this fact, the EDP system can interlink the contents to be displayed in a playback program. This can be done locally, or alternatively in a decentralized manner too.

The layout means preferably can access the information from all displays, meaning in particular their display capacities with regard to dimensions and potentially the pixel numbers. The layout means can then relay the contents to be depicted to the various displays based on the data known to them via the display devices and based on the links transmitted by the content linking means, preferably in real time or with a short time delay to enable buffering.

The respective displays are then perceived as especially marginally disruptive if the lighting system exhibits graphic enhancement means for the display device. In particular a media always has a decorative component relative to the architecture of the building on which it is installed. In order to make this correlation physically perceivable, individual programs can be generated to set up purely artistic graphic structures. These structures can be self-developing, for example, so as to develop further in a way not predictable by a random or impartial observer. The resultant graphic enhancements are then variably integrated with the contents available to the layout means. For example, it may be perceived as pleasant for just the graphic enhancements to appear on a media façade form time to time, or for them to be graphically superposed with the contents relayed by the layout means from the content pool.

The EDP system is preferably set up in such a way that at least the graphic enhancement means can interactively react to external influences like weather or time of day. These data can be centrally processed by the EDP system, in particular when the lighting system only operates a single display device, or when the various display devices are installed in close proximity to each other. However, if the various displays are distributed over a larger area, for example over an urban area or across several cities, it is suggested that corresponding sensors and graphic mixing means be installed locally on a display device. The mixing means then take the data provided by the layout means and transform them with the enhancement means.

The content linking means and/or layout means and/or graphic enhancement means preferably generate a program that changes continually on its own. This is perceived as very pleasant as a whole by the observer, or above all by an inhabitant next to a display installed in an open space.

The lighting system preferably has control means for the content pool, the content linking means, the layout means and/or the graphic enhancement means. In this case, control means for the content pool can be in particular means for accessing the existing database, with which an operator of a display device can selectively delete the existing content and/or add new content. The control means for the content pool should also make it possible to input the content designations for the contents.

The control means for the content linking means can be used to logically interlink the existing contents with their respective content designations in various ways. For example, these control means can also enable overlapping links, meaning contents of a first category with the contents of a second category. The control means should first and foremost allow the content linking means to relay graphically or acoustically displayable data directly to the layout means, and hence to the displays, without going through the content pool. For example, this can be used to quickly insert a breaking news story.

The control means for the layout means can in particular prescribe a different chronological sequence, thereby turning the lighting components on and off more inertly or dynamically. As an alternative and additionally, they can be used to set the preferred number of content to be simultaneously shown on a display. In this way, the layout means can minimize the content more given an elevated number of graphic depictions of contents in the middle to be shown simultaneously, preferably without graphic distortions.

The lighting system is preferably set up in such a way as to transmit the contents as arranged content in the form of various graphic planes to the display device.

Graphic planes refer to various graphic depictions, which can be mutually overlapped and displayed by the layout means on the display device.

The individual planes can be semi-transparent, so that if a plane lying above is currently not illuminated on the display, the plane lying below it is displayed.

It is proposed that each content designation exhibit a profile data record, which ascribes a relevance to a respective prescribed number of properties.

For example, it is conceivable to assign such a profile to all respective content data, whether text, video or graphics. All data are separated into individual modular components, and individually provided with a profile. However many properties desired are assigned to the module as a result, so as to unambiguously describe it. A canon of properties is defined for each project of a lighting system operator, and used to describe all media modules of this project.

A prototype model of the inventor utilizes six properties. The extent to which a respective property is accurate as a description for each specific module is individually set. To this end, an importance level of “not applicable” to “fully applicable” can be set in a control program. Each module is thereby set up with an individual mix of various level settings, i.e., lower to higher, with respect to the predetermined properties, and then stored.

A control program in the logic center is used to enable modules with similar properties to find each other, and appear together on the image-generating medium. Interlinking the modules makes it possible both to organize the linear chronological sequence of the modules, as well as to synchronize and overlap the modules.

Therefore, the introduced system replaces the function of the classic video cut. Video is now cut procedurally, and calculated online in the lighting system.

To describe it differently, the individual contents are combined by setting up an n-dimensional space, specifically based on the number of properties in the profile. In the described prototype system, this is a six-dimensional space, and the individual modules have a six-dimensional alignment. The system organizes the content data in such a way that modules with similar alignment find each other.

Of course, other rules can be defined, for example that only modules least similar to each other are found and interlinked.

The n-dimensional data space is preferably divided into separate clusters. This makes it possible to thematically break down the data space. The current programming jumps back and forth between the clusters based on individually determinable rules.

If only the programming described above is present, the modules still meet in a relatively uncontrolled manner. Therefore, it is proposed that the lighting system exhibit a series of tools, with which the media modules can be harmonized with each other:

It us first consider a “content machine”.

Various pools with content of varying mentality can be set up in the overall system. The media modules inside these pools can have various looks. The objective is to be able to integrate as much variety in the programming. To this end, a controller was developed for use to access the various media modules in a continuously new sequence.

Graphic zones are employed in the form of a clock, which define the access to a specific contingent of media modules. These zones revolve around the fulcrum of the “content machine”. It has a cursor at a specific location, which records which zones are currently active in what area. This gives the lighting system the signal to search out a media module from precisely this contingent.

The graphic zones can be set up in whatever size and number desired. It would be advantageous if varying speeds for the individual zones could also be selected. This causes the zones to shift relative to each other within the “content machine.

Several content machines can be interconnected by organizing them in hierarchical order. The respectively higher ranking content machine exhibits an empty space at some point once the zones have rotated correspondingly, i.e., predominantly circular segments. This empty space then signals the activation of the next content machine. This is how varying content pools are procedurally intermixed.

“Graphic tools” represent yet another tool.

Therefore, the object is to have various tools on hand for use in shaping the appearance of the media modules. For example, a text can be set up in terms of its size, color and position. It can also be determined whether the text runs into the image from right or left, or if it simply appears.

How images and videos emerge can also be set. In particular, they can be faded in and out.

If several images appear at the same time, plane functions are preferably activated to determine the form in which the images overlap. This offers virtually unlimited design capabilities.

Special effects can essentially also be set in this way, influencing the design for all media modules.

A third tool would be a “content mixer”.

This is preferably intended for content management, which is authoritatively ranked over the procedural control of the lighting system, and can organize a precisely determined insertion at specific times of day. This makes it possible to guarantee specific insertion on the media façade.

The lighting system preferably exhibits logging means that log the insertion of content.

Since the insertion of content on the display devices is largely random or at least very complicated to predict, the logging means can advantageously precisely determine when and for how long a specific media module was inserted. This makes it possible to calculate inserted advertisements, and tailor them based on a preset budget.

Profiling allows the controlled lighting system to also set up intelligent links, thereby increasing the value of the respectively inserted advertisement. For example, a trademark/brand that correlates with the marketing target group of the trademark can be inserted right after information about a specific event in a city has been presented. The information about the cultural event elevates the attentiveness of the observer, so that the advertisement can be placed very efficiently. Information and advertisement interact.

The lighting system can easily organize an automatic dramaturgical distribution of the content throughout the day. For example, one can decide whether to insert a quiet or lively sequence in the course of the day. This increases the chance that media facades will be approved, since the cities must protect their citizenry against sensory overload in open spaces.

The controlled illuminating system can individually adjust the visual intensity to the location and time of day. This allows the city to identify areas of the city with defined intensity levels for electronic media using a set of design rules. This becomes exceedingly relevant when a specific density of media facades has developed in the cities. It will then also become necessary to correlate the programming of the media facades in terms of design and content, since the uncontrolled playback of numerous media facades in close proximity to each other generates a “white noise”, meaning that the observer might not be able to hone in specifically on any media façade given the wide array of images.

By contrast, the controlled lighting system for media facades introduced here can effectively commingle the dramaturgy of the media facades and, for example, establish deliberately controlled programming pauses.

The controlled lighting system can integrate another interactive controller that takes external influences like weather and daylight into account. This interactivity can in turn be used to enhance attractiveness. For example, the traffic light phase of an opposite intersection can be determined so as to insert specific content when motor vehicles are stopped. This makes it possible to charge relatively high prices for advertising time.

Let yet another approach be taken to explain that the controlled lighting system introduced here is the foundation for an entirely new media format. The visual aesthetic is first and foremost geared toward capturing the moment, not the narrative communication of ideas, as previously the case. Concentrating on the moment and aiming at a constantly changing structure of image sequences makes it possible to harmoniously integrate the moving images in urban areas. The controlled illuminating system also adjusts how information is editorially imparted to the cognitive ability of the recipient.

This also stimulates a new way of advertising in open spaces. The introduced lighting system no longer requires the prefabricated advertisement clip, but rather creates a highly complex system that constantly generates new constellations of images and messages. The video segment is replaced by an intelligent

The observer of a media façade subconsciously adjusts his perception to his television viewing habits. Therefore, he expects the program to be editorially shaped. But this is an economically unjustifiable expense for media facades. As a result, a traditionally operated media façade program quickly gives rise to a certain level of frustration and disinterest, since the expectations of the recipient are not confirmed. This has ramifications with respect to the efficiency of conventional media facades, if the latter are to yield a pecuniary profit for the owner by way of inserted advertisements. The inventor believes that media façade advertising will find success on the market if it produces successful effects in the manner described above utilizing a controlled lighting system.

The controlled lighting system makes it possible to give advertisement a new orientation. Only the controlled lighting system of the kind proposed here makes it possible to organize advertisements with a different content, such as infotainment and media art, organically superposed on a media façade. This new aesthetic results in a new attractiveness. The market of electronic media in open spaces can only be opened up over the long term proceeding in this way.

In sum, this kind of controlled lighting system hence makes it possible to display the content of image files, video files, music files and text files on one or more display surfaces in such a way that the depiction program is not perceived as disruptive. Therefore, the use of such a system for controlling the displays enables a universally applicable playback program for the operator of such a lighting system.

The invention will be described in greater detail below based on an exemplary embodiment, drawing reference to the drawing.

Shown on the sole FIGURE is a diagrammatic depiction of a controlled lighting system, with a display variably fed from a content pool.

The lighting system 1 initially provides a large database, namely the content pool 2. The content pool 2 is the basis for the entire recording program of a large media façade 3, which is 20 m wide and roughly 100 m high, and installed on a vertical building façade.

The content pool 2 is a server, which stores video clips, graphics and standard text. The files for the content are stored there in various groups, but each content file (labeled 4, 5 by example) in particular exhibits an individual designation, which reflects the content-related properties of the single file based on specific criteria. In particular, the properties contain information about the dimensions of an image in pixels, the run time of a video clip, the thematic content and the client of the operator, who transmits the content to the operator and has paid fees for the depiction.

The content pool 2 is part of an EDP system. Another part of the EDP system is a processor, which is arranged in a logical module, the “logic center” 6, and has access to the content pool 2 and the content 4, 5 located there. Depending on the local conditions, the logic center 6 can be integrated with the content pool 2 or separated form it.

The contents 4, 5 from the content pool 2 are brought into contact via the content designations in the logic center 6. As a result, for example, a video clip can now be automatically and logically put in relation to a graphic and/or a text statement. A logical link between the two contents 4, 5 as determined by the logic center 6 is relayed by the logic center 6 to the “graphic center” 7.

The graphic center 7 generates the layout of the two files 4, 5 to be shown on the display 3, combining them into a sorted graphic, for this purpose. It here takes into account the geometric dimensions and pixel resolution of the display surface 3.

The graphic center 7 accesses the contents 4, 5 of the content pool 2 via the logic center 6, or directly if desired, and relays the latter to a sorted graphic arranged on a graphic mixer 8. The graphic mixer 8 passes the data on to the display 3, either by way of an information technology platform 9 or in a direct manner. The contents 4, 5 are there relayed as arranged contents 4′, 5′.

The display of arranged contents 4′, 5′ is graphically enhanced by a program 10, which itself generates continuously changing graphic art. The processor 10 can here be equipped with various sensors, and react, for example, to the time of day, temperature or current precipitation levels.

The interactive media pool platform 9 puts together the recording program for the media façade 3 in such a way that the program automatically and continually changes. To this end, various media levels are variably superposed under computer control. The operating platform 9 serves as an interface between the EDP system 2, 6, 7, 10, 8, 9 and the operator of the media façade 3. The operator can incorporate new data into the content pool 2 however desired. He can also directly set up current data for display on the media façade 3, independently of the content pool 2.

The platform 9 also offers setting options, with which the synchronized settings in the logic center 6 and graphic center 7 can be individually adjusted. The system 1 makes it possible to program various media facades as well.

In general, the controlled lighting system sets up the recording program for the media facades in such a way that the program continuously changes on its own. To this end, various media levels are superposed in a variable manner, controlled by computer.

The basis for this is the content pool. This is a server that stores video clips, graphics and standard text. This yields very small media modules, which viewed separately are not meaningful.

The individual files are provided with an individual profiling, which describes the content-related properties of the individual files. As a result, each file receives its own character, so to speak.

The files are now brought into contact with each other in the logic center based on the properties of the media modules. The computer searches an individual control system for files that are similar. In this way, a video clip is logically automatically correlated with a graphic and text statement.

The performance on the imaging medium, for example the media façade, is calculated online by the server. There is no linear structure in the recording program; it rather comes about organically, and is always renewed by the procedural controller.

The files are subsequently combined into a sorted graphic in the graphic center on the surface of the medial façade. Rules are there defined to variably set up the graphic appearance of the individual media modules. In this case, for example, how characters are displayed is regulated here, along with how the font can or should appear in relation to an underlying image.

The content pool has an interface in the form of a user platform, with which the provider of the media façade can individually incorporate data into the content pool. In addition, he can use the content pool to directly set up current data and/or change the set of rules in the program.

In sum, then, there is a five-stage lighting system, specifically with the content pool, the logic center, the graphic center, the software platform and the media façade.

The content server stores the video clips, graphics and standard texts, each with their profile. Various content pools can be present on the content server.

The logic center uses the profiles to link the media data, and also accesses the content machines, which mix the contents together. The content machines can be used to retrieve the varying content pools in the content server.

The software platform makes it possible to individual plan the recorded media. For example, a freely programmable content mixer is available to the operator. In addition, there is an interface that can access the content server, so as to call the contents from there, and/or store the currently incorporated media modules there.

The system 1 makes it possible to also jointly program recordings for various media facades 3 having different dimensions. This is especially advantageous where media facades are to be synchronized with each other in terms of content in a municipal planning architectonic context. In the absence of such synchronization, there is a risk that the visual effect of several facades will cancel each other out.

In sum, a system of the kind described yields a programming culture for displays installed in open spaces, in particular media facades, which creates a new type of media format. Among other things, it allows the system to handle and integrate advertisements for media facades in such a way that approvable systems can be reported to the cities and municipalities in the open road systems.

1. A controlled lighting system (1) with a display device (3) having a flat display and an EDP system (2, 6, 7, 10, 8, 9) that controls the display device (3),
wherein the EDP system (2, 6, 7, 10, 8, 9) has access to the content pool (2), and is set up to feed the display (3) with content (4, 5) from the content pool (2),
wherein the EDP system (2, 6, 7, 10, 8, 9) exhibits content linking means (6) that are set up to establish logical links between content (4, 5) respectively provided with content designations,
wherein the EDP system (2, 6, 7, 10, 8, 9) exhibits layout means (7), to which links are relayed,
and wherein the layout means (7) are set up to arrange the linked content (4, 5) in such a way from a chronological and/or geometrical standpoint as to depict (4′, 5′) the latter on the display device (3) via the lighting system.

2. The lighting system according to claim 1, wherein the display device (3) is installed in an open space.

3. The lighting system according to claim 1, comprising several display devices (3), in particular by at least three display devices, each with different aspect ratios.

4. The lighting system according to claim 1, comprising a display that can be actuated by means of pixels.

5. The lighting system according to claim 1, wherein the display device (3) exhibits a rectangular shape with an aspect ratio of narrower than 16:9.

6. The lighting system according to claim 1, wherein several display devices (3) are distributed across a city, or in particular across several cities.

7. The lighting system according to claim 1, comprising graphic enhancement means (10) for the display device (3).

8. The lighting system according to claim 1, wherein the content linking means (6) and/or the layout means (7) generate a continually changing program of arranged content (4′, 5′) for the display device (3).

9. The lighting system according to claim 1, comprising control means (9) for the content pool (2), the content linking means (6) and/or the layout means (7).

10. The lighting system according to claim 1, wherein the contents (4, 5) exhibit image files, video files, music files and/or text files.

11. The lighting system according to claim 1, wherein the contents (4, 5) are transmitted to the display device (3) as arranged content (4′, 5′) in the form of different graphic planes.

12. The lighting system according to claim 1, wherein each content designation exhibits a profile data record, which ascribes a relevance to a respective prescribed number of properties.

13. The lighting system according to claim 1, comprising logging means that log the insertion of content (4, 5).

14. Use of a controlled lighting system (1), in particular according to claim 1, for controlling a display device (3) with a flat display in open spaces, in particular for controlling a media façade.

15. Use according to claim 14 for controlling several media facades with varying dimensions.
